(19) United States
(12) Patent Application Publication
(10) Pub. No.: US 2026/0003666 A1
(43) Pub. Date: Jan. 1, 2026

(54) Intelligent Event Management and Data Integrity Validation System

(71) Applicant: Bank of America Corporation, Charlotte, NC (US)

(72) Inventors: George Albero, Charlotte, NC (US); Naga Vamsi Krishna Akkapeddi, Charlotte, NC (US)

(21) Appl. No.: 18/760,175

(22) Filed: Jul. 1, 2024

(51) Int. Cl. G06F 9/46; G06F 9/48

(52) U.S. Cl. CPC G06F 9/466; G06F 9/4818

(57) ABSTRACT

Arrangements for providing data integrity validation in event processing are provided. A computing platform may detect a communication interruption between a first and second system. The platform may identify data from the second system that cannot be retrieved. A decision tree may be used to identify transaction details for processing by a third system and the transaction may be passed to the third system for processing. When the interruption is resolved, the first system may retrieve the data from the second system, generate a token including the data and publish the token to the platform, where the third system may retrieve the token and evaluate the data for formatting. If formatting is required, a second decision tree may be used to identify a transformation to perform. Machine learning may be used to transform the data and the third system may process the transaction using the formatted data.

### BACKGROUND

Aspects of the disclosure relate to electrical computers, systems, and devices for event management and data integrity validation.

Enterprise organizations process thousands or maybe even millions of events each day. However, connectivity between systems or applications within an event processing system can be unpredictable. Interruptions in communications between systems or applications can lead to delays, data integrity validation issues, and may increase necessary computing bandwidth in order to process events, in some cases, multiple times once all data is available. Accordingly, conventional arrangements may include holding an event at a current application or system until connectivity is restored and data is available for retrieval. In other examples, conventional arrangements may include deleting the event and processing the event from the beginning once connectivity is restored and data is available. However, both of these arrangements require increased computing bandwidth and are inefficient. Accordingly, arrangements described herein provide for dynamic event processing that enables continued processing while some data might not be available and enables efficient retrieval of data that has become available due to restored connectivity.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with ensuring data integrity in event processing.

In some aspects, a computing platform may receive a request to process an event or transaction. Processing the event or transaction may be performed by a plurality of systems or applications in a transaction processing operation or system. The computing platform may monitor for interruptions in communication between two or more systems or applications. In some examples, the computing platform may detect a communication interruption between a first and second system. The computing platform may identify data from the second system that cannot be retrieved due to the interruption but is used for processing at a third system. A decision tree may be used to identify mandatory and optional transaction details for processing by the third system and the transaction may be passed to the third system for processing of the available data.

Upon detecting that the interruption is resolved, the first system may retrieve the data from the second system and generate a token including the data. The first system may publish the token to the computing platform where the third system may retrieve the token and evaluate the data for formatting issues. Upon determining that the data requires formatting, a second decision tree may be used to identify a type of transformation to perform on the data. A machine learning model may then be used to transform the data using the identified type of transformation and the third system may process the transaction using the formatted data.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing event management and data integrity validation in accordance with one or more aspects described herein;

FIGS. 2A-2G depict an illustrative event sequence for event management and data integrity validation in accordance with one or more aspects described herein;

FIG. 3 illustrates an illustrative method for event management and data integrity validation according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, event processing may include processing by a series of applications and/or systems that may rely on data or information from previous or other applications or systems in the transaction processing operation. For instance, data at one system or application may be enriched by data at another system or application and the enriched data may be processed by yet another system or application. Accordingly, when communication and/or connectivity between the systems or applications is interrupted, data might not be validated and/or delays and/or errors in processing may occur that may impact data and/or event integrity.

Arrangements described herein provide dynamic event processing. As discussed more fully here, when a disruption in communication between systems or applications is detected, processing of the event may continue, rather than being held until the data is available or restarted when the data is available, in order to efficiently and accurately process events. In some examples, a first decision tree may be used to determine mandatory and optional event details for processing at a “next” or subsequent system or application. The event may be passed to that system for continued processing and, when data impacted by the disruption is available, the data may be tokenized and published to a space monitored by the next or subsequent application or system. The data may be retrieved and a second decision tree may be used to determine a type of transformation to perform on data to ensure proper formatting for processing at the next or subsequent system or application. A machine learning model may be used to format data using the type of transformation determined by the decision tree. The formatted data may then be used to process the event.

These and various other arrangements will be discussed more fully below.

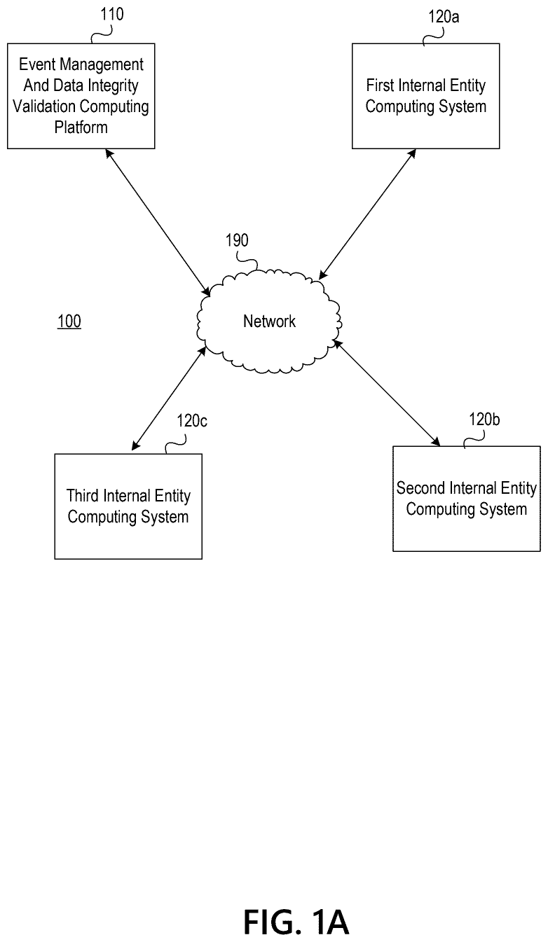

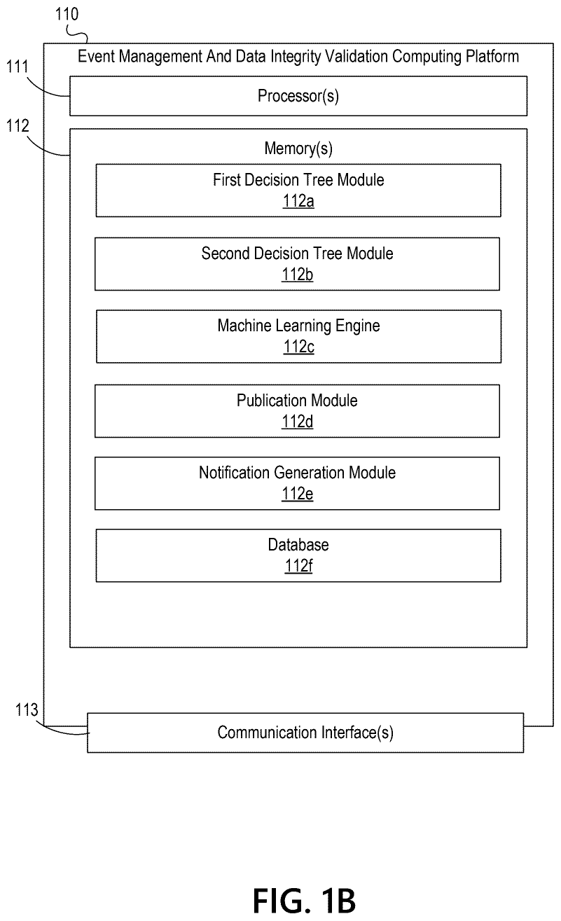

FIGS. 1A-1B depict an illustrative computing environment and devices for implementing event management and data integrity validation in accordance with one or more aspects described herein. Referring to FIG. 1A, computing environment 100 may include one or more computing devices and/or other computing systems. For example, computing environment 100 may include event management and data integrity validation computing platform 110, first internal entity computing system 120a, second internal entity computing system 120b, and third internal entity computing system 120c.

Although three internal entity computing systems 120a, 120b, and 120c, are shown, any number of systems or devices may be used without departing from the invention.

Event management and data integrity validation computing platform 110 may be configured to perform intelligent, dynamic, real-time data integrity validation in order to process one or more events or transactions. For instance, event management and data integrity validation computing platform 110 may monitor transaction or event processing in a transaction processing operation. For instance, in some examples, processing a transaction may include processing different portions or steps of the transaction at different systems executing different applications. For instance, a transaction may include an initial processing step at a first system executing, for instance, a first application, retrieval of documents from a second system executing a second application, and data validation at a third system executing a third application. In conventional arrangements, the steps of the process may be performed in series because each system or application may include data to be processed at a subsequent system or application. However, the event management and data integrity validation computing platform 110 may processing at least some portions of the transaction in parallel in order to efficiently move the transaction through the system.

For instance, a transaction may be received by a first system (e.g., first internal entity computing system 120a). The transaction may be intercepted by the event management and data integrity validation computing platform 110 which may monitor transaction processing at various systems or applications to detect potential issues. In some examples, the first system may perform initial transaction processing functions. Further, the first system may attempt to retrieve data from a second system (e.g., second internal entity computing system 120b) that may be used in processing at a subsequent system. However, in some examples, a connectivity issue may prevent the first system from retrieving the data from the second system. Accordingly, the first system may request, from event management and data integrity validation computing platform 110 identification of mandatory and optional parts of the transaction for processing at the third system. Accordingly, event management and data integrity validation computing platform 110 may execute a first decision tree to identify the data or content that is mandatory for processing at the third system, as well as data or content that is optional at the third system. The transaction may then be forwarded to the third system (e.g., internal entity computing system 120c) with all available data (e.g., any available mandatory and optional data).

Upon determination that connectivity is restored between the first system and the second system, the first system may generate a token and publish the token to the event management and data integrity validation computing platform 110. The token may include a transaction identifier, source application or system identifier or name, a time stamp of the transaction, a target system or application name, as well as newly available content (e.g., content retrieved from the second system upon connectivity being restored), and the like. In some examples, the third system (and/or other systems) may monitor a publication space within event management and data integrity validation computing platform 110 and may detect the published token. The third system may determine that the content associated with the token is not in a required format and, accordingly, may transmit the content associated with the token, to the event management and data integrity validation computing platform 110 to determine a type of transformation needed to format the data to the required format. For instance, the event management and data integrity validation computing platform 110 may execute a second decision tree to identify the type of transformation needed to format the data.

The third system may provide, to the event management and data integrity validation computing platform 110, the content of the event token, as well as the application or system identifier or name, transaction type and type of transformation identified by the second decision tree to a machine learning model executed by the event management and data integrity validation computing platform 110. The machine learning model may output transformed data in the required format for the third system and processing of the transaction may continue. The event management and data integrity validation computing platform 110 may then update or validate the machine learning model.

First internal entity computing system 120a, second internal entity computing system 120b, and/or third internal entity computing system 120c may each include one or more computer components (e.g., servers, server blades, memory, processors, or the like) that may host or execute one or more applications of an enterprise organization. In some examples, first internal entity computing system 120a, second internal entity computing system 120b, and/or third internal entity computing system 120c may be a plurality of internal entity computing systems that work together to process transactions in a transaction processing operation. In some examples, each system may host an application to process a particular part of a transaction. Accordingly, processing a transaction or event may include executing a processing function at an internal entity computing system and sending the processed data or transaction to a next system for processing a next portion of the transaction. The process may continue through the various internal entity computing systems until the transaction or event processing is complete.

While three internal entity computing systems are shown, the arrangements described herein may include any number of systems. Further, while aspects described are provided in the contents of a connectivity issue between a first system and a second system, this is just one example. The arrangements described herein may be used to efficiently processing transactions when an issue occurs at any phase of the transaction or event processing process and should not be limited to issues between a first and second system or application.

As mentioned above, computing environment 100 also may include one or more networks, which may interconnect one or more of event management and data integrity validation computing platform 110, first internal entity computing system 120a, second internal entity computing system 120b, and/or third internal entity computing system 120c. For example, computing environment 100 may include network 190, which may be a public or private network. Network 190 may include one or more sub-networks (e.g., Local Area Networks (LANs), Wide Area Networks (WANs), or the like). Network 190 may interconnect one or more computing devices associated with the organization. For example, event management and data integrity validation computing platform 110, first internal entity computing system 120a, second internal entity computing system 120b, and/or third internal entity computing system 120c may be connected via network 190 to interconnect event management and data integrity validation computing platform 110, first internal entity computing system 120a, second internal entity computing system 120b, and/or third internal entity computing system 120c.

Referring to FIG. 1B, event management and data integrity validation computing platform 110 may include one or more processors 111, memory 112, and communication interface 113. A data bus may interconnect processor(s) 111, memory 112, and communication interface 113. Communication interface 113 may be a network interface configured to support communication between event management and data integrity validation computing platform 110 and one or more networks (e.g., private network 190, or the like). Memory 112 may include one or more program modules having instructions that when executed by processor(s) 111 cause event management and data integrity validation computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of event management and data integrity validation computing platform 110 and/or by different computing devices that may form and/or otherwise make up event management and data integrity validation computing platform 110.

For example, memory 112 may have, store and/or include first decision tree module 112a. First decision tree module 112a may store instructions and/or data that may cause or enable the event management and data integrity validation computing platform 110 to execute a first decision tree to identify mandatory and/or optional parts of a transaction for processing at a particular system or application. For instance, first decision tree module 112a may include a first decision tree that, upon receiving identification of a “next” system in the transaction processing operation, may identify mandatory and/or optional parts of the data or content for processing at the “next” system or application.

Event management and data integrity validation computing platform 110 may further have, store, and/or include second decision tree module 112b. Second decision tree module 112b may store instructions and/or data that may cause or enable the event management and data integrity validation computing platform 110 to execute a second decision tree to identify a type of transformation needed to format data or content to a required format. For instance, the second decision tree may identify, based on content received from a system or application, a type of transformation needed to format the data or content to a format required by the system or application.

Event management and data integrity validation computing platform 110 may further have, store and/or include machine learning engine 112c. Machine learning engine 112c may store instructions and/or data that cause or enable the event management and data integrity validation computing platform 110 to train, execute, update and/or validate a machine learning model. For instance, machine learning engine 112c may train a machine learning model to receive, as inputs, content from an event token, an application or system identifier or name, a transaction type and/or a type of transformation needed to properly format the data (e.g., as determined from the second decision tree) and output, upon execution of the model, transformed data that includes the content of the token in a format required by a system or application currently processing the transaction.

The machine learning model may be trained using historical data related to transformed data, type of transformations, information related to data requirements of various systems or applications, and the like. For instance, data associated requirements of various systems or applications, as well as previous transformations of different determined transformations types and transaction types may be used to train a machine learning model to transform the data from a first format to a second format that may be required by a system or application processing the event.

In some examples, the machine learning model may be or include one or more supervised learning models (e.g., decision trees, bagging, boosting, random forest, neural networks, linear regression, artificial neural networks, logical regression, support vector machines, and/or other models), unsupervised learning models (e.g., clustering, anomaly detection, artificial neural networks, and/or other models), knowledge graphs, simulated annealing algorithms, hybrid quantum computing models, and/or other models. In some examples, training the machine learning model may include training the model using labeled data (e.g., labeled data including transaction type, system or application name, and the like) and/or unlabeled data.

Event management and data integrity validation computing platform 110 may further have, store and/or include publication module 112d. Publication module 112d may store instructions and/or data that may cause or enable the event management and data integrity validation computing platform 110 to provide, to one or more systems or applications (e.g., first internal entity computing system 120a, second internal entity computing system 120b, third internal entity computing system 120c, and the like) a repository for receiving content tokens generated by a system and including, for instance, data or content that was previously unavailable (e.g., due to connectivity issues), is currently available and has been provided for use in a subsequent system processing a portion of the transaction. Accordingly, systems monitoring the publication module 112d, may determine that previously unavailable data is available and may retrieve the missing data for use in processing the respective portion of the transaction.

Event management and data integrity validation computing platform 110 may further have, store and/or include notification generation module 112e. Notification generation module 112e may store instructions and/or data that may cause or enable the event management and data integrity validation computing platform 110 to generate one or more notifications indicating that a connectivity issue is detected, that connectivity is restored, that processing is complete, or the like. The notifications may be transmitted or sent to one or more computing devices.

Event management and data integrity validation computing platform 110 may further include database 112f. Database 112f may store data to perform the functions of the event management and data integrity validation computing platform 110.

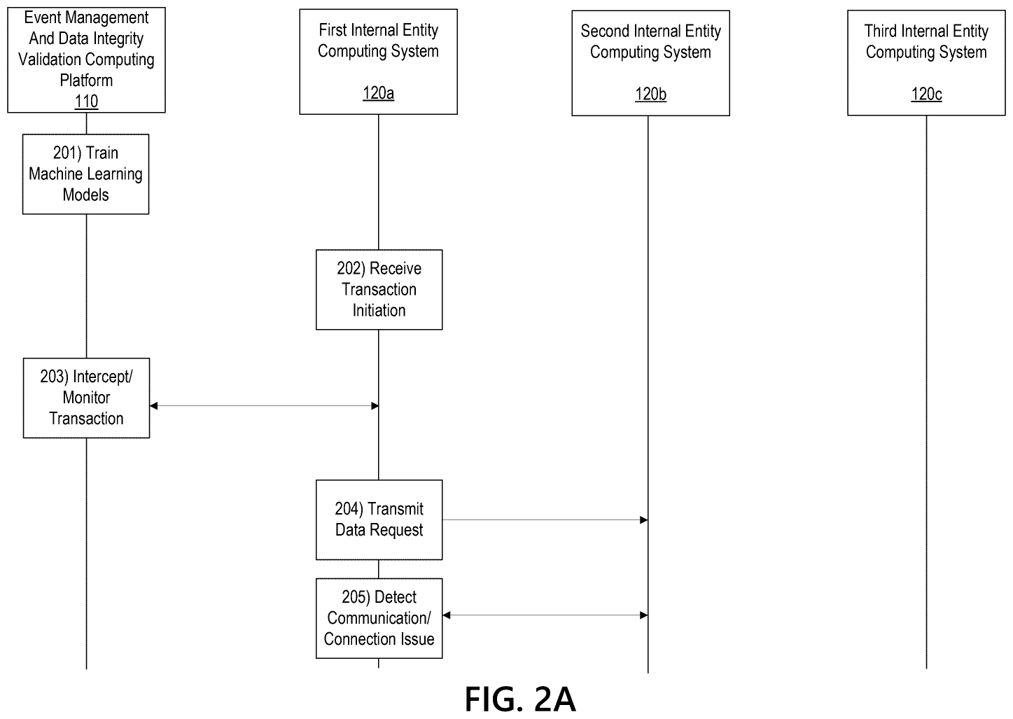

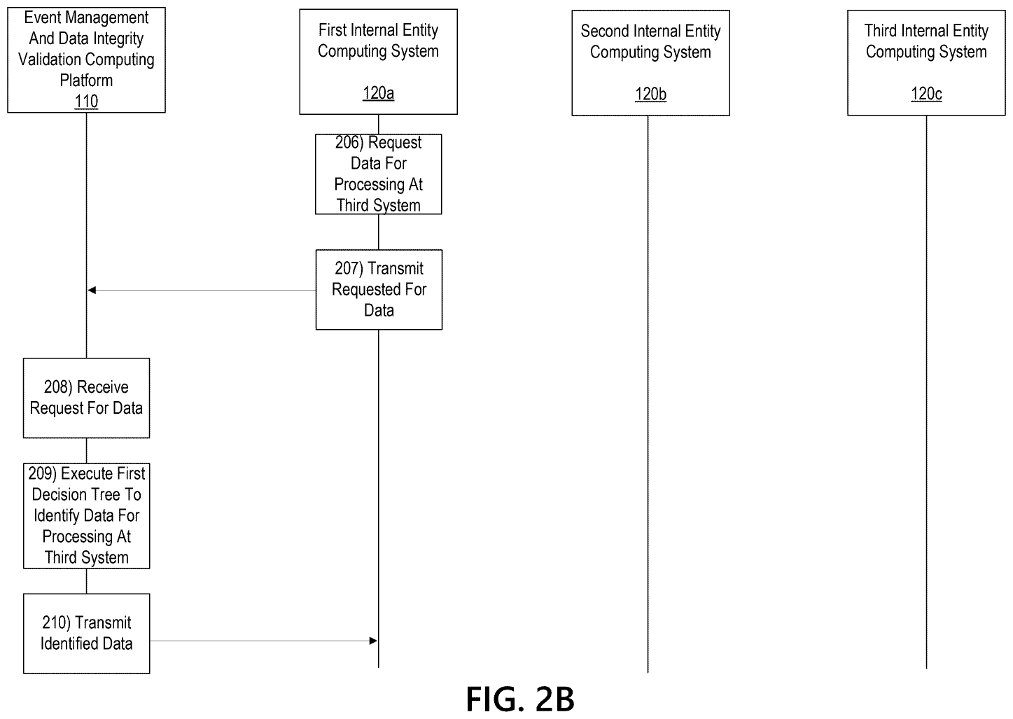

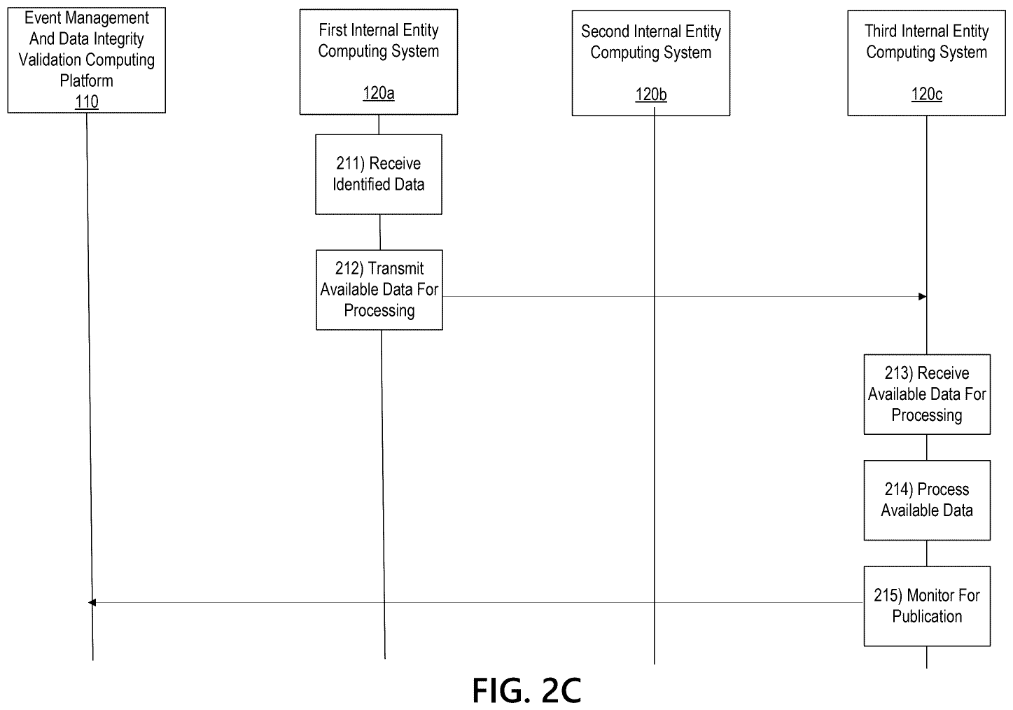

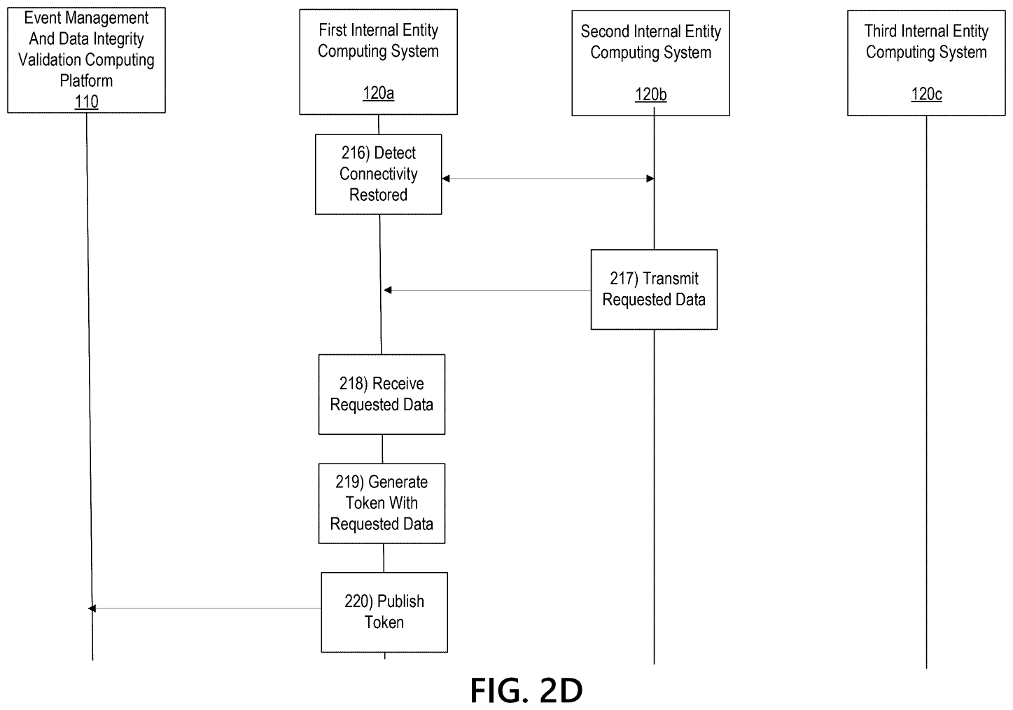

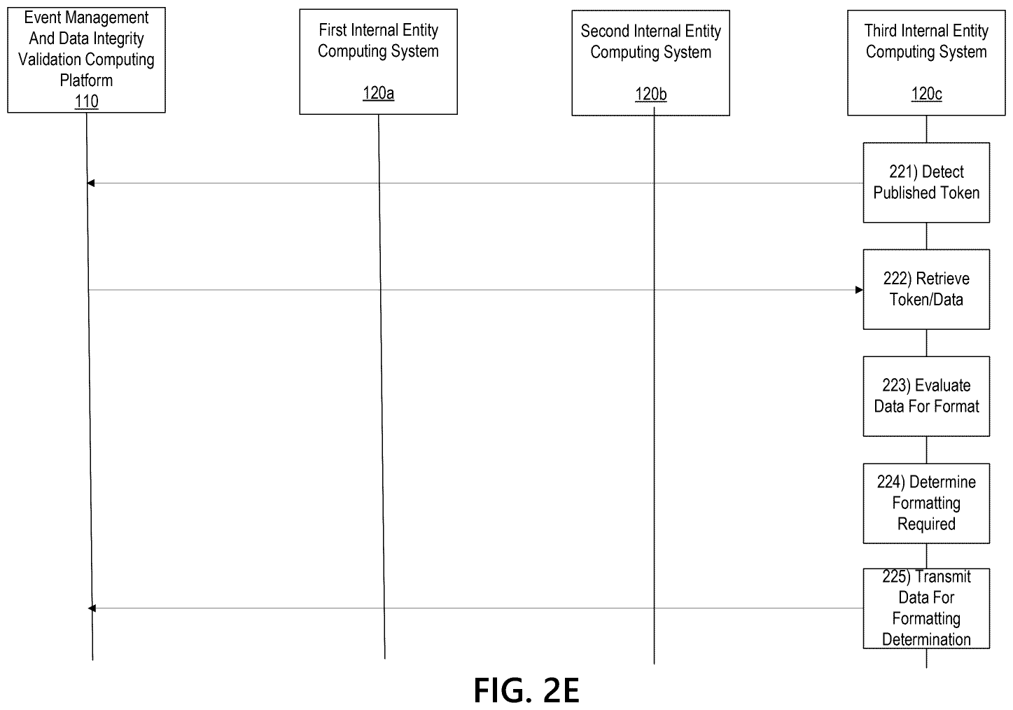

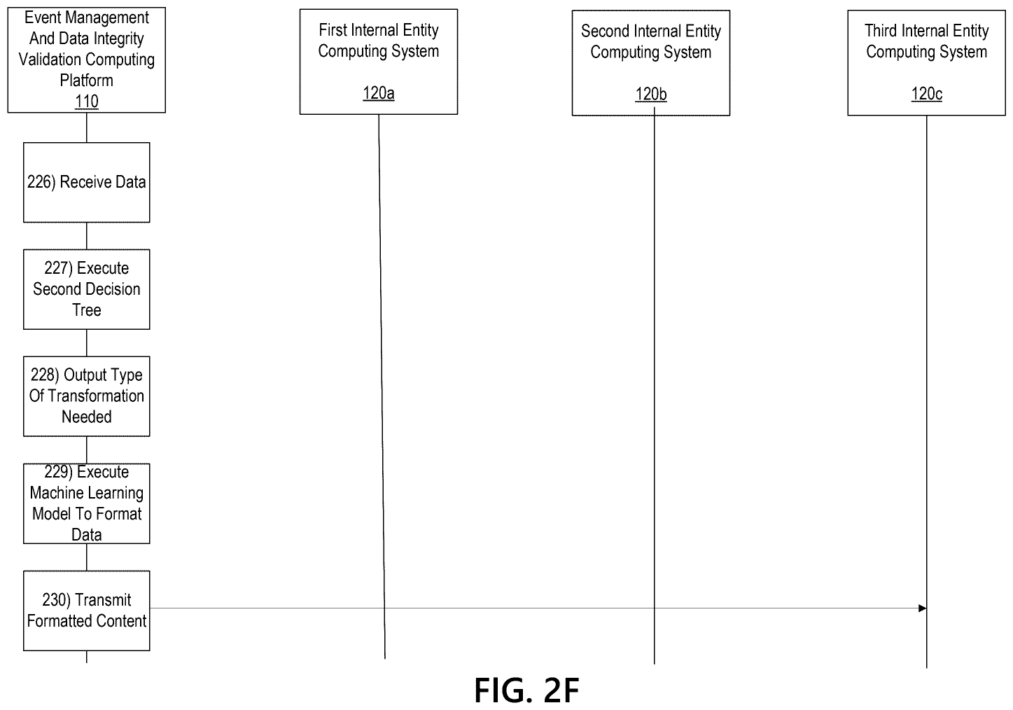

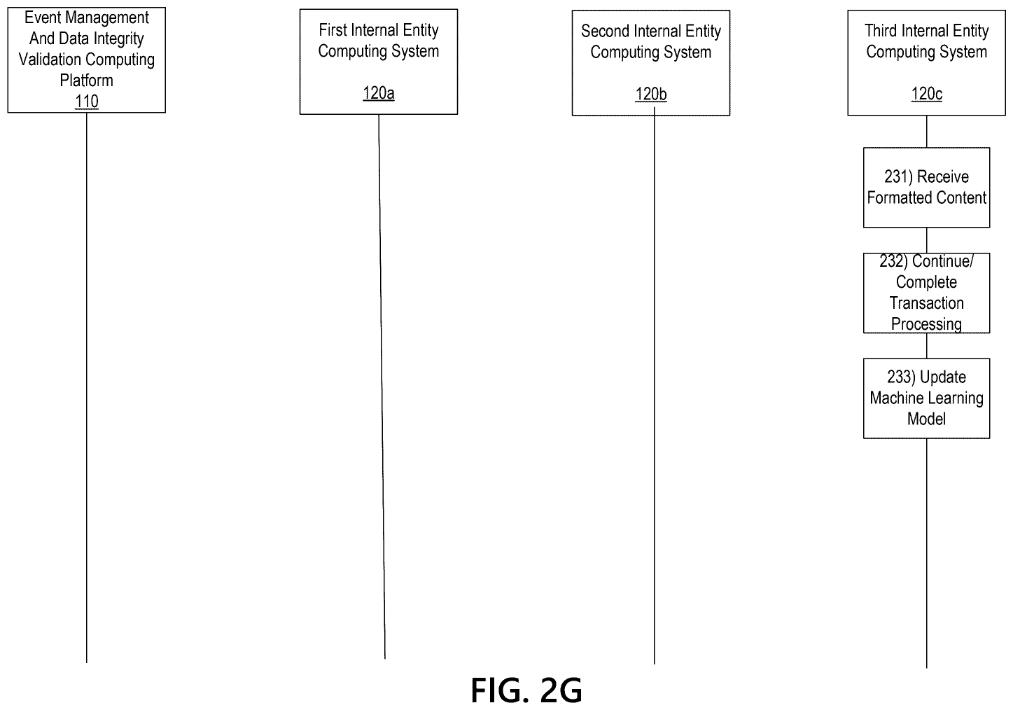

FIGS. 2A-2G depict one example illustrative event sequence for event management and data integrity validation in accordance with one or more aspects described herein. The events shown in the illustrative event sequence are merely one example sequence and additional events may be added, or events may be omitted, without departing from the invention. Further, one or more processes discussed with respect to FIGS. 2A-2G may be performed in real-time or near real-time.

With reference to FIG. 2A, at step 201, event management and data integrity validation computing platform 110 may train one or more machine learning model. For instance, event management and data integrity validation computing platform 110 may train a first decision tree to identify, based on inputs related to a system or application (e.g., a “next” system or application in the transaction processing operation), data that is mandatory and/or optional for processing at the system or application. In some examples, supervised learning may be used to train the first decision tree based on data related to various systems or applications, types of data used by each system or application, labelled data identifying mandatory or optional portions of the data, and the like.

Event management and data integrity validation computing platform 110 may further train a second decision tree to identify, based on an identified system or application, a type of transformation necessary to transform data or content from a first format to a second format required by the identified system or application. In some examples, supervised learning may be used to train the second decision tree based on data requirements of one or more systems or applications, and the like.

Event management and data integrity validation computing platform 110 may further train a machine learning model to receive, as inputs, content from a token identified for formatting, an application or system name or identifier, a transaction type, and a type of transformation identified by the second decision tree to modify or transform the data or content from the token from a first format to a second format. For instance, the machine learning model may perform the type of transformation identified by the second decision tree on the data to generate data in a necessary format for a particular system or application.

At step 202, first internal entity computing system 120a, may receive initiation of a transaction. For instance, first internal entity computing system 120a may receive initiation of a transaction for processing by a transaction processing operation including a plurality of internal entity computing systems or applications that may each process a portion of a transaction or event. The first internal entity computing system 120a may perform initial processing of the transaction and may identify additional data needed from one or more other systems for processing by subsequent systems or applications.

At step 203, event management and data integrity validation computing platform 110 may monitor the first internal entity computing system 120a to detect initiated transactions and identify potential issues that may prevent first internal entity computing system 120a, or subsequent systems, from processing the transaction or a respective portion of the transaction or event. For instance, event management and data integrity validation computing platform 110 may monitor first internal entity computing system 120a to detect issues associated with first internal entity computing system 120a from retrieving data from one or more other systems, such as second internal entity computing system 120b.

Although step 203 is described as monitoring first internal entity computing system 120, event management and data integrity validation computing platform 110 may monitor one or more other systems (e.g., second internal entity computing system 120b, third internal entity computing system 120c, or the like) to detect issues at any point in the process.

At step 204, first internal entity computing system 120a may attempt to transmit a request for data to the second internal entity computing system 120b. At step 205, first internal entity computing system 120a may detect a connectivity or other communication issue that may prevent first internal entity computing system 120a from connecting to and/or retrieving the requested data from second internal entity computing system 120b.

With reference to FIG. 2B, at step 206, first internal entity computing system 120a may generate a request for data for processing at a third system (e.g., a “next” processing system in the transaction processing operation that may correspond to third internal entity computing system 120c). The request may include identification of the third system (e.g., third internal entity computing system 120c) and may include a request to identify types of data or content that are mandatory for processing at the third system and/or are option for processing at the third system.

At step 207, the first internal entity computing system 120a may transmit or send the request for data for processing at the third system to the event management and data integrity validation computing platform 110.

At step 208, event management and data integrity validation computing platform 110 may receive the request for data for processing at the third system.

At step 209, event management and data integrity validation computing platform 110 may execute the first decision tree. For instance, based on the identified third system, event management and data integrity validation computing platform 110 may execute the first decision tree to identify types of data or content that are mandatory for processing at the third system, as well as types of data or content that may be optional for processing at the third system. In some examples, optional items may include items that may be provided at a later step or system in the process, are not required at all, or the like.

At step 210, event management and data integrity validation computing platform 110 may transmit or send the identified optional and/or mandatory data identified for the third system to the first internal entity computing system 120a.

With reference to FIG. 2C, at step 211, first internal entity computing system 120a may receive the identified mandatory and/or optional data. In some examples, first internal entity computing system 120a may identify whether data requested but not retrieved from second internal entity computing system 120b is mandatory or optional. In some examples, if the data is mandatory, the first internal entity computing system 120a may prioritize monitoring for resumed communication and prioritize publication of the data. Additionally or alternatively, if the data requested from second internal entity computing system 120b is optional, first internal entity computing system 120a might not generate a token and/or publish the token/data (e.g., because the transaction may be processed, in some examples, without the data).

At step 212, first internal entity computing system 120a may transmit or send the available data (e.g., any portion of the transaction processed by the first internal entity computing system 120a and/or any other data for processing subsequent portions of the transaction that are available) to the third internal entity computing system 120c.

At step 213, third internal entity computing system 120c may receive the available data transmitted or sent by the first internal entity computing system 120a.

At step 214, third internal entity computing system 120c may process the available data. Accordingly, instead of the transaction being held at the first internal entity computing system 120a until all data is available, the transaction processing may continue at third internal entity computing system 120c that may process any portion of the transaction able to be processed based on the data received at step 213.

At step 215, third internal entity computing system 120c may monitor the event management and data integrity validation computing platform 110 for publication of additional data. For instance, when connectivity or communication resumes, first internal entity computing system 120a may retrieve the data from second internal entity computing system 120b and may publish the data as available for retrieval by third internal entity computing system 120c. Accordingly, third internal entity computing system 120c (as well as other systems) may monitor the publication module of the event management and data integrity validation computing platform 110 to detect any published tokens related to processing the portion of the event or transaction performed at the third internal entity computing system 120c.

With reference to FIG. 2D, at step 216, first internal entity computing system 120a may detect that connectivity and/or communication has been restored between the first internal entity computing system 120a and the second internal entity computing system 120b and/or that information requested by the first internal entity computing system 120a from the second internal entity computing system 120b may be available. Accordingly, the request for data transmitted by the first internal entity computing system 120a to the second internal entity computing system 120b at step 204 may be completed and/or resent.

At step 217, second internal entity computing system 120b may receive the request for data and may respond by transmitting the requested data to first internal entity computing system 120a.

At step 218, first internal entity computing system 120a may receive the data requested from the second internal entity computing system 120b.

At step 219, first internal entity computing system 120a may generate a token including the retrieved data from the second internal entity computing system 120b. In some examples, the token may include not only the retrieved data but also a transaction identifier, source system or application identifier or name, time stamp of the transaction, target system or application identifier or name, and the like.

At step 220, first internal entity computing system 120a may publish the token to the event management and data integrity validation computing platform 110. For instance, the first internal entity computing system 120a may publish the generated token to the publication module of the event management and data integrity validation computing platform 110 which may enable other systems or applications to access the token and associated data.

With reference to FIG. 2E, at step 221, third internal entity computing system 120c may detect (e.g., based on monitoring the publication module of the event management and data integrity validation computing platform 110) the publication of the token by the first internal entity computing system 120a. In some examples, third internal entity computing system 120c may determine whether the published token is related to an event or transaction being processed by the third internal entity computing system 120c (e.g., based on transaction identifier, time stamp, or the like).

If the token relates to the third internal entity computing system 120c, third internal entity computing system 120c may retrieve the token from the event management and data integrity validation computing platform 110 at step 222.

At step 223, third internal entity computing system 120c may extract the content data (e.g., data from internal entity computing system 120b for processing) and may analyze the content to determine whether the data or content is in a format required for processing by the third internal entity computing system 120c. At step 224, the third internal entity computing system may determine whether formatting is needed. If no formatting is needed, the processing may continue at step 232 in FIG. 2G.

If formatting of the data is needed, at step 225, the third internal entity computing system 120c may transmit or send the data to the event management and data integrity validation computing platform 110 to determine a type of transformation. For instance, third internal entity computing system 120c may transmit or send information related to the system or application of the third internal entity computing system to the event management and data integrity validation computing platform 110. In some examples, third internal entity computing system 120c may also send the content or data (e.g., the data being transformed), an application or system identifier or name, and/or a type of transaction.

With reference to FIG. 2F, at step 226, event management and data integrity validation computing platform 110 may receive the data and, at step 227, event management and data integrity validation computing platform 110 may execute the second decision tree to determine a type of transformation needed for the data. For instance, based on the content or data, as well as the system or application processing the data (e.g., internal entity computing system 120c), the second decision tree may identify or determine a type of transformation to perform on the data or content to format the data to a format required by third internal entity computing system 120c.

Accordingly, at step 228, the type of transformation may be output by the second decision tree.

At step 229, the machine learning model may be executed to transform the data. For instance, the machine learning model may receive, as inputs, the data or content being formatted, the name or identifier of the system or application, the type of transaction and the type of transformation output by the second decision tree and, upon execution, may format the data to the necessary format based on the type of transformation.

At step 230, event management and data integrity validation computing platform 110 may transmit or send the formatting data to the third internal entity computing system 120c.

With reference to FIG. 2G, at step 231, third internal entity computing system 120c may receive the formatted content.

At step 232, the third internal entity computing system 120c may continue or complete processing of the requested transaction (e.g., transaction requested at step 202). For instance, if the third internal entity computing system 120c is the final system or application in the transaction processing operation, the transaction may be processed to completion by third internal entity computing system 120c based on the received formatted data. Alternatively, if additional systems or applications downstream of third internal entity computing system 120c are part of the transaction processing operation, the transaction, and processed data, may be transmitted to a “next” system or application for further processing.

Although the arrangements described herein include evaluating a single connectivity issue for a single transaction, various transaction may be processed in parallel and issues in multiple transactions or multiple issues within a single transaction may be identified and processed using the arrangements described herein without departing from the invention.

At step 233, event management and data integrity validation computing platform 110 may update and/or validate the machine learning model. For instance, based on the processed transaction and/or downstream additional processing of the transaction, the machine learning model may be updated via a dynamic feedback loop. Accordingly, the machine learning model may be continuously or near-continuously updated to improve accuracy in outputting environmental impact scores and recommendations.

In some instances, event management and data integrity validation computing platform 110 may continuously update, validate, refine, or the like, the machine learning model. In some examples, the event management and data integrity validation computing platform 110 may maintain an accuracy threshold for the machine learning model and may pause refinement (through the dynamic feedback loop) of the model if the corresponding accuracy is identified as greater than the accuracy threshold. Further, if the accuracy is at or below the accuracy threshold, the event management and data integrity validation computing platform 110 may resume refinement of the model through the corresponding dynamic feedback loop.

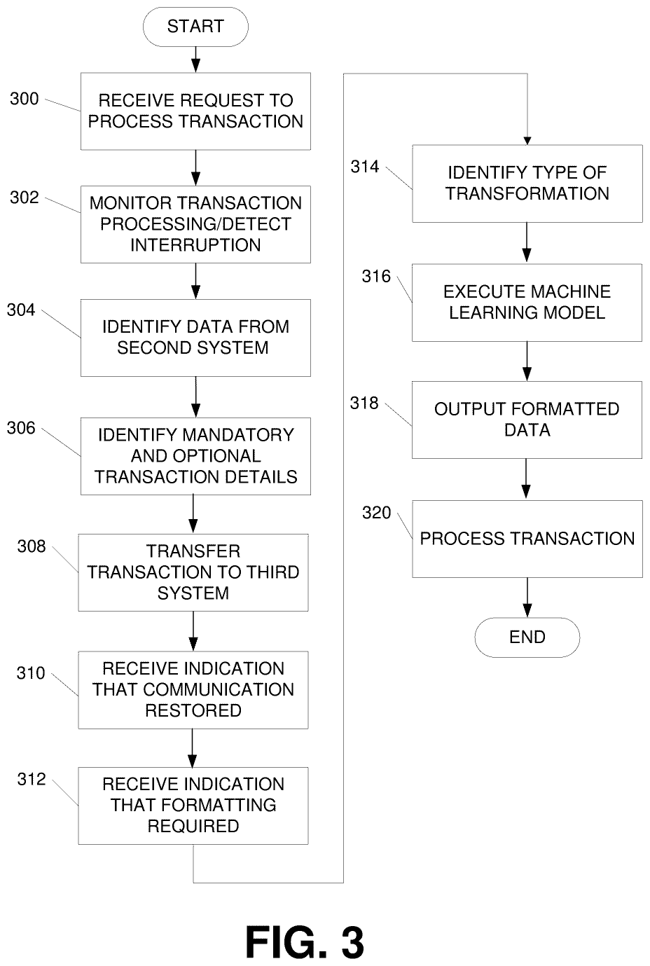

FIG. 3 is a flow chart illustrating one example method of event management and data integrity validation in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, event management and data integrity validation computing platform 110 may receive a request to process a transaction. In some examples, the request may be received by a system or application of a plurality of systems or applications within a transaction processing operation configured to process one or more transactions and may be intercepted or detected by the event management and data integrity validation computing platform 110 based on monitoring of the plurality of systems or applications within the transaction processing operation.

At step 302, the event management and data integrity validation computing platform 110 may monitor the transaction processing operation (e.g., the plurality of systems or applications within the transaction processing operation) to detect that a communication connection between one or more systems of the plurality of systems has been interrupted. For instance, the event management and data integrity validation computing platform 110 may monitor the plurality of systems and may detect that a communication connection between a first system of the plurality of systems and a second system of the plurality of systems has been interrupted (e.g., the first system cannot retrieve data from the second system due to the interruption).

At step 304, the event management and data integrity validation computing platform 110 may identify or receive identification of data to be retrieved from the second system by the first system in order to process the transaction (e.g., at a third or other subsequent system in the transaction processing operation). In some examples, event management and data integrity validation computing platform 110 may receive identification of the data from the first system.

At step 306, the event management and data integrity validation computing platform 110 may execute a first decision tree to identify transaction details of the transaction that are mandatory and transaction details of the transaction that are optional, in order to further process the transaction at the third (or other subsequent) system. In some examples, the first decision tree may receive, as inputs, identification of the third system in order to determine or output the mandatory and optional transaction details.

At step 308, the transaction may be transferred to the third system for further processing. For instance, although the first system was not able to retrieve particular data from the second system, the transaction may be sent to the third system and the third system may then begin processing the available data (e.g., rather than holding the transaction at the first system until the data from the second system is available).

At step 310, event management and data integrity validation computing platform 110 may receive an indication that the communication connection between the first system and the second system has been restored. In some examples, the indication may include a token including the identified data retrieved from the second system when the communication connection was restored. In some examples, the first system may retrieve the data (when available), generate the token (e.g., upon restoration of the communication connection), and publish the token to the event management and data integrity validation computing platform 110, where other systems of the plurality of systems may monitor for available data. In some examples, the token may further include a transaction identifier, a name of the first system, a time stamp of the transaction, and/or a name of the third system.

At step 312, upon publication of the token, the third system may retrieve the token and evaluate the data to determine whether the format of the data is in a required format. If not, the event management and data integrity validation computing platform 110 may receive (e.g., from the third system) an indication that the identified data retrieved from the second system is not in a required format. In some examples, the required format may be required for processing by the respective system processing the data (e.g., the third system). In some examples, the indication may include the content of the token, a name or identifier of the third system, and a transaction type.

In response to the indication, at step 314, the event management and data integrity validation computing platform 110 may execute a second decision tree to identify a type of transformation to perform on the data or content retrieved from the second system in order to format the data in the required format. In some examples, the second decision tree may receive, as inputs, the content and/or identification of the third system as the system processing the data.

At step 316, the event management and data integrity validation computing platform 110 may execute a machine learning model. In some examples, executing the machine learning model may include receiving, as inputs, an application or system name or identifier associated with the third system, the transaction type, the type of transformation needed to translate the identified data retrieved from the second system to the required format (e.g., as output by the second decision tree) and the identified data retrieved from the second system (e.g., the data or content being formatted). At step 318, upon execution of the model with the inputs, the machine learning model may output the formatted data.

At step 320, the formatted data may be transmitted to the third system and the third system may process the transaction using the formatted data.

Accordingly, the arrangements described herein provide for dynamic, non-linear processing of events. In some examples, aspects of the event processing may be pre-staged in order to be ready to immediately resume processing once missing data has been published to the computing platform.

As discussed herein, the arrangements include a first decision tree configured to identify aspects or transaction details that are mandatory and/or optional. The arrangements may further include a second decision tree that may determine whether formatting or translation of data is needed. For instance, in some event processing arrangements, payment data must be in a particular format. The second decision tree may identify a type of translation or transformation to be performed on the payload data in order to enable processing by a current or subsequent system or application in the transaction processing operation. In some examples, the second decision tree may include all applications or systems and what translations are needed for each application or system.

The arrangements described may further include a machine learning model configured to format the payload data. The machine learning model may receive, as inputs, the payload data or content, an application or system identifier, a type of transaction and a type of transformation identified by the second decision tree. The machine learning model may be executed and may output the formatted data.

As discussed herein, the arrangements described may be performed at any system or application in the transaction processing operation. For instance, a disruption in communication may occur between any systems and the arrangements described herein may be used to continue processing with available data and retrieve data when published.

For instance, in some examples, an event for processing a loan application may require a copy of a document stored at a second system. Attaching a link or copy of the document may be mandatory to complete the processing of the transaction but might not be needed to process other aspects of the event or transaction (e.g., verifying a user's employment or income, verifying the applicant's address, or the like). Accordingly, if a disruption occurs that prevents a first system from retrieving the document from the second system, the transaction may be passed to a third system for continued processing of the loan application using the available data. When communication is restored and the document is retrieved by the first system from the second system, the first system may tokenize the document or data and publish it so that the third system may retrieve the published token and process the transaction.

In another example, a transaction may include processing an invoice. In some examples, all data may be extracted from the invoice and used for processing at a first system. However, a copy of the invoice, stored at a second system, might be unavailable due to a communication interruption. Accordingly, the first system may pass the transaction and invoice data for further processing (e.g., to verify an amount of available funds or other processing). When the copy of the invoice becomes available, the first system may retrieve the copy, tokenize it and publish it. The third system may retrieve the published token, evaluation the format and rely on the second decision tree and machine learning model to identify a type of transformation and transform the data to the proper format. The transaction may then be processed using the formatted data.

In still another example, a transaction or event may include sending a user a new credit card. In some examples, a first system may begin processing the request for a new card and may attempt to retrieve shipping data from a second system. An interruption in communication may prevent the first system from obtaining the shipping information. However, the first system may pass the transaction to a third system to generate the card, package and ship the card. When the shipping information becomes available, the third system may retrieve the published data, communication with the second decision tree and machine learning model to format the data as needed and complete processing of the transaction. Accordingly, fewer delays may be encountered due to the non-linear processing described herein.

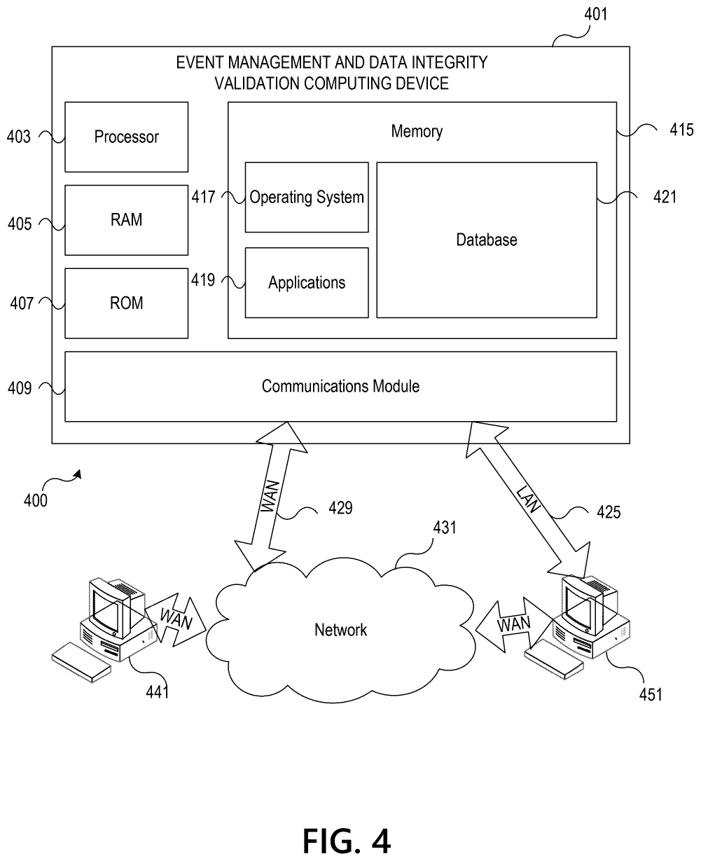

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include event management and data integrity validation computing device 401 having processor 403 for controlling overall operation of event management and data integrity validation computing device 401 and its associated components, including Random Access Memory (RAM) 405, Read-Only Memory (ROM) 407, communications module 409, and memory 415. Event management and data integrity validation computing device 401 may include a variety of computer readable media. Computer readable media may be any available media that may be accessed by event management and data integrity validation computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by event management and data integrity validation computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on event management and data integrity validation computing device 401. Such a processor may execute computer-executable instructions stored on a computer-readable medium.

Software may be stored within memory 415 and/or storage to provide instructions to processor 403 for enabling event management and data integrity validation computing device 401 to perform various functions as discussed herein. For example, memory 415 may store software used by event management and data integrity validation computing device 401, such as operating system 417, application programs 419, and associated database 421. Also, some or all of the computer executable instructions for event management and data integrity validation computing device 401 may be embodied in hardware or firmware. Although not shown, RAM 405 may include one or more applications representing the application data stored in RAM 405 while event management and data integrity validation computing device 401 is on and corresponding software applications (e.g., software tasks) are running on event management and data integrity validation computing device 401.

Communications module 409 may include a microphone, keypad, touch screen, and/or stylus through which a user of event management and data integrity validation computing device 401 may provide input, and may also include one or more of a speaker for providing audio output and a video display device for providing textual, audiovisual and/or graphical output. Computing system environment 400 may also include optical scanners (not shown).

Event management and data integrity validation computing device 401 may operate in a networked environment supporting connections to one or more remote computing devices, such as computing devices 441 and 451. Computing devices 441 and 451 may be personal computing devices or servers that include any or all of the elements described above relative to event management and data integrity validation computing device 401.

The network connections depicted in FIG. 4 may include Local Area Network (LAN) 425 and Wide Area Network (WAN) 429, as well as other networks. When used in a LAN networking environment, event management and data integrity validation computing device 401 may be connected to LAN 425 through a network interface or adapter in communications module 409. When used in a WAN networking environment, event management and data integrity validation computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive a request to process a transaction, wherein processing the transaction includes processing the transaction at a plurality of systems in a transaction processing operation;
monitor the transaction processing operation to detect that a communication connection between a first system and a second system of the plurality of systems in the transaction processing operation has been interrupted;
identify data to retrieve from the second system to process the transaction;
identify, based on output from a first decision tree, transaction details that are mandatory and transaction details that are optional for further processing the transaction at a third system of the plurality of systems of the transaction processing operation;
transfer the transaction to the third system for further processing;
receive an indication that the communication connection between the first system and the second system has been restored, wherein the indication includes a token including the identified data retrieved from the second system when the communication connection was restored;
receive an indication that the identified data retrieved from the second system is not in a required format;
identify, based on output from a second decision tree, a type of transformation needed to translate the identified data retrieved from the second system to the required format;
execute a machine learning model, wherein executing the machine learning model includes inputting, to the machine learning model, an application name associated with the third system, a transaction type, the type of transformation needed to translate the identified data retrieved from the second system to the required format and the identified data retrieved from the second system to output a transformed version of the identified data retrieved from the second system in the required format; and
process, by the third system, the transaction using the transformed version of the identified data retrieved from the second system in the required format.

2. The computing platform of claim 1, wherein the required format is required for processing by the third system.

3. The computing platform of claim 1, wherein the output from the first decision tree is based on identifying the third system as a next system for processing the transaction in the transaction processing operation.

4. The computing platform of claim 1, wherein the token further includes a transaction identifier, a name of the first system, a time stamp of the transaction, and a name of the third system.

5. The computing platform of claim 1, wherein the output from the second decision tree is based on identifying the third system as a next system for processing the transaction in the transaction processing operation and the identified data retrieved from the second system.

6. The computing platform of claim 1, wherein the token is generated by the first system.

7. The computing platform of claim 6, wherein the token is generated upon restoration of the communication connection.

8. The computing platform of claim 6, wherein the token is published to the computing platform by the first system.

9. A method, comprising:
receiving, by a computing platform, the computing platform having at least one processor, and memory, a request to process a transaction, wherein processing the transaction includes processing the transaction at a plurality of systems in a transaction processing operation;
monitoring, by the at least one processor, the transaction processing operation to determine that a communication connection between a first system and a second system of the plurality of systems in the transaction processing operation has been interrupted;
identifying, by the at least one processor, data to retrieve from the second system to process the transaction;
identifying, by the at least one processor and based on output from a first decision tree, transaction details that are mandatory and transaction details that are optional for further processing the transaction at a third system of the plurality of systems of the transaction processing operation;
transferring, by the at least one processor, the transaction to the third system for further processing;
receiving, by the at least one processor, an indication that the communication connection between the first system and the second system has been restored, wherein the indication includes a token including the identified data retrieved from the second system when the communication connection was restored;
receiving, by the at least one processor, an indication that the identified data retrieved from the second system is not in a required format;
identifying, by the at least one processor and based on output from a second decision tree, a type of transformation needed to translate the identified data retrieved from the second system to the required format;
executing, by the at least one processor, a machine learning model, wherein executing the machine learning model includes inputting, to the machine learning model, an application name associated with the third system, a transaction type, the type of transformation needed to translate the identified data retrieved from the second system to the required format and the identified data retrieved from the second system to output a transformed version of the identified data retrieved from the second system in the required format; and
processing, by the third system, the transaction using the transformed version of the identified data retrieved from the second system in the required format.

10. The method of claim 9, wherein the required format is required for processing by the third system.

11. The method of claim 9, wherein the output from the first decision tree is based on identifying the third system as a next system for processing the transaction in the transaction processing operation.

12. The method of claim 9, wherein the token further includes a transaction identifier, a name of the first system, a time stamp of the transaction, and a name of the third system.

13. The method of claim 9, wherein the output from the second decision tree is based on identifying the third system as a next system for processing the transaction in the transaction processing operation and the identified data retrieved from the second system.

14. The method of claim 9, wherein the token is generated by the first system.

15. The method of claim 14, wherein the token is generated upon restoration of the communication connection.

16. The method of claim 14, wherein the token is published to the computing platform by the first system.

17. One or more non-transitory computer-readable media storing instructions that, when executed by a computing platform comprising at least one processor, memory, and a communication interface, cause the computing platform to:
receive a request to process a transaction, wherein processing the transaction includes processing the transaction at a plurality of systems in a transaction processing operation;
monitor the transaction processing operation to determine that a communication connection between a first system and a second system of the plurality of systems in the transaction processing operation has been interrupted;
identify data to retrieve from the second system to process the transaction;
identify, based on output from a first decision tree, transaction details that are mandatory and transaction details that are optional for further processing the transaction at a third system of the plurality of systems of the transaction processing operation;
transfer the transaction to the third system for further processing;
receive an indication that the communication connection between the first system and the second system has been restored, wherein the indication includes a token including the identified data retrieved from the second system when the communication connection was restored;
receive an indication that the identified data retrieved from the second system is not in a required format;
identify, based on output from a second decision tree, a type of transformation needed to translate the identified data retrieved from the second system to the required format;
execute a machine learning model, wherein executing the machine learning model includes inputting, to the machine learning model, an application name associated with the third system, a transaction type, the type of transformation needed to translate the identified data retrieved from the second system to the required format and the identified data retrieved from the second system to output a transformed version of the identified data retrieved from the second system in the required format; and
process, by the third system, the transaction using the transformed version of the identified data retrieved from the second system in the required format.

18. The one or more non-transitory computer-readable media of claim 17, wherein the output from the first decision tree is based on identifying the third system as a next system for processing the transaction in the transaction processing operation.

19. The one or more non-transitory computer-readable media of claim 17, wherein the token further includes a transaction identifier, a name of the first system, a time stamp of the transaction, and a name of the third system.

20. The one or more non-transitory computer-readable media of claim 17, wherein the output from the second decision tree is based on identifying the third system as a next system for processing the transaction in the transaction processing operation and the identified data retrieved from the second system.
